(19) United States
(12) Patent Application Publication
(10) Pub. No.: US 2014/0191991 A1
(43) Pub. Date: Jul. 10, 2014

(54) RESPONDING TO A TOUCH INPUT

(71) Applicant: MOTOROLA MOBILITY LLC, Libertyville, IL (US)

(72) Inventors: Christian L. Flowers, Chicago, IL (US); Nathan M. Connell, Hawthorn Woods, IL (US); Michael F. Olley, Lake Zurich, IL (US); Michael E. Gunn, Barrington, IL (US)

(73) Assignee: MOTOROLA MOBILITY LLC, Libertyville, IL (US)

(21) Appl. No.: 14/135,356

(22) Filed: Dec. 19, 2013

Related U.S. Application Data
(60) Provisional application No. 61/748,794, filed on Jan. 4, 2013.

(51) Int. Cl. G06F 1/32; G06F 3/041

(52) U.S. Cl. CPC G06F 1/3262; G06F 3/041
USPC 345/173

(57) ABSTRACT

Disclosed are systems and methods for responding to a touch input at a user computing device such as a mobile phone, smart phone, tablet, PC or other device. In one aspect, such systems and methods are performed on an electronic device including a touch-input system, a first processor, and a second processor distinct from the first processor. Disclosed systems and methods include, while the first processor is in a sleep mode, receiving, by the second processor from the touch-input system, information associated with a touch, the information including a location of the touch on a screen of the touch-input system and, based, at least in part, on the location of the touch, either ignoring the touch or waking the first processor.

### CROSS-REFERENCE TO RELATED APPLICATION

The present application claims priority to U.S. Provisional Patent Application 61/748,794, filed on Jan. 4, 2013, which is incorporated herein by reference in its entirety.

### TECHNICAL FIELD

The present disclosure is related generally to user-interface techniques for computing devices and, more particularly, to a system and method for responding to a touch input on a user interface of a computing device.

### BACKGROUND

As mobile devices have diminished in size, new methods of user input have developed. For example, while user input was initially received exclusively via hardware such as buttons and sliders, users are now able to interface with many mobile devices via touch-screen inputs. Despite the general effectiveness of such input methods, the methods often consume a great deal of power from an internal power source due to the requirement of an always-on processor. Enhanced input technology regarding processor power schemes could play a role in providing greater power saving capabilities.

The present disclosure is directed to a system that may provide enhanced power saving capabilities. However, it should be appreciated that any such benefits are not a limitation on the scope of the disclosed principles or of the attached claims, except to the extent expressly noted in the claims. Additionally, the discussion of technology in this Background section is merely reflective of inventor observations or considerations and is not an indication that the discussed technology represents actual prior art.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a perspective view of an example embodiment in accordance with the present invention;

FIG. 2 is a generalized schematic of an example device within which the presently disclosed innovations may be implemented;

FIG. 3 is a schematic of an example configuration of the processors and touch input of FIG. 2;

FIG. 4 is a flowchart of a representative method for responding to a touch input in accordance with the disclosed principles;

FIG. 5 is a schematic of an example configuration of the processors and touch input of FIG. 2; and

FIG. 6 is a flowchart of a representative method for responding to a touch input in accordance with an embodiment of the disclosed principles.

### DETAILED DESCRIPTION

In overview of the disclosed principles, an electronic device may include two processors, that is, a first processor and a second processor. The first processor is a general purpose (or “application”) processor. While broadly capable, this first processor tends to use a significant amount of power, which may present an energy-use challenge for small, battery-powered devices. To address the issue of excessive power consumption and for other reasons, the electronic device's second processor may use significantly less power than the first processor. In some embodiments this second, low power, processor may be or include a sensor hub.

In an example method for responding to a touch input, the first processor is placed in a very low power (or “sleep”) mode. While the first processor sleeps, the second processor monitors the environment of the device. Based on this monitoring, the second processor may decide that the device needs to perform some task beyond the capabilities of the second processor. For example, the second processor may detect a button press or a swipe gesture from a user that indicates that the user wishes to interact with the device. In this situation, the second processor wakes up the first processor. The first processor then performs whatever work is required of it.

Eventually, there may be no more work for the first processor to perform. For example, the user may eventually finish his interaction with the device and put the device in a pocket. At this point, the first processor goes to sleep in order to save power, while the second processor remains on, sensing the environment. In some embodiments, while the first processor is asleep, the second processor monitors a touch-input system for specific inputs. If an input is received that is one of a set of specific inputs, then the second processor wakes the first processor to respond to the input; otherwise, the input is ignored. In one example of a specific input, the second processor may ignore all inputs except a “wake up” touch gesture from the user. In some implementations, the touch-input system itself is intelligent enough to recognize gestures. In such examples, the touch-input system instructs the second processor as to what type of gesture has been received. In other implementations, the second processor interprets touch information itself to determine if a specific gesture has been performed.

In another example, the second processor may logically divide a screen of the touch-input system into “live” and “non-live” areas. For example, just before the first processor goes to sleep, it may display one or more selectable icons on the screen, or the first processor may tell the second processor to display these icons. Areas associated with these icons are considered to be “live,” while the remainder of the screen is considered to be non-live. If, while the first processor is asleep, a touch is received that corresponds to a location of one of these icons, then the second processor wakes the first processor. Touches received in non-live areas are ignored. Because the designation of areas of the screen as live or non-live ultimately depends upon the first processor, these areas may change.

There are multiple options for connecting the first and second processors. In one implementation, touch events are sent in parallel to both processors. When the second processor wakes the first processor in this embodiment, the first processor already has access to the relevant touch event. In another implementation, all touch events go only to the second processor. If the second processor decides to wake the first processor in this embodiment, then the second processor sends the relevant touch event to the first processor.

Turning to the drawings, wherein like reference numerals refer to like elements, techniques of the present disclosure are illustrated as being implemented in a suitable environment. The following description is based on example embodiments and should not be taken as limiting the claims with regard to alternative embodiments that are not explicitly described herein.

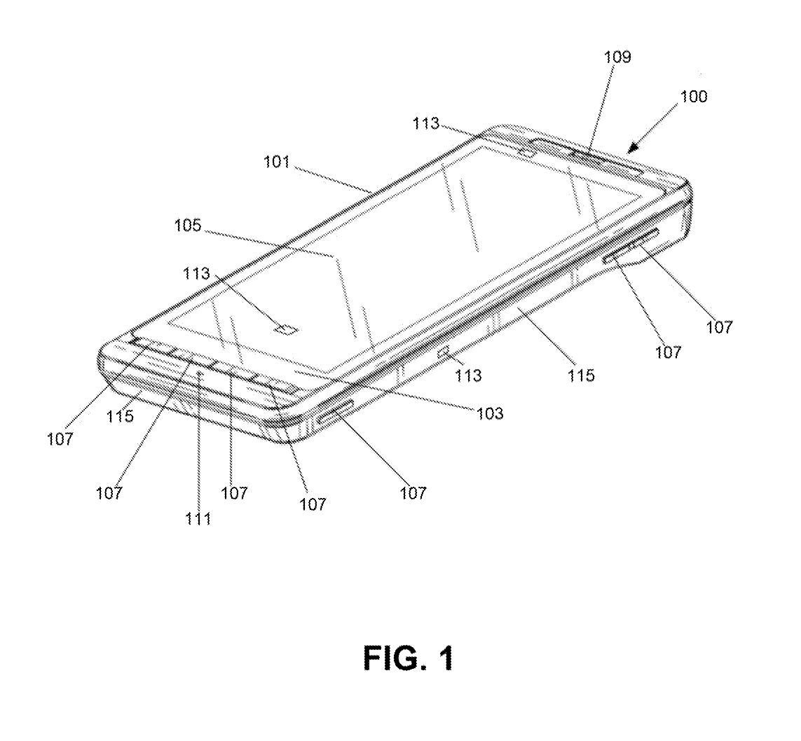

Referring now to FIG. 1, a perspective view of an example electronic device 100 is illustrated. The electronic device 100 may be any type of device capable of providing touch-screen interactive capabilities. Example electronic devices 100 include, but are not limited to, electronic devices, wireless devices, tablet computing devices, personal digital assistants, personal navigation devices, touch-screen input devices, touch- or pen-based input devices, portable video or audio players, cellular telephones, smart phones, and the like. It is to be understood that the electronic device 100 may take the form of a variety of form factors, such as, but not limited to, bar, tablet, flip cam, slider, and rotator form factors.

In an example embodiment, the electronic device 100 has a housing 101 comprising a front surface 103 which includes a visible display 105 and a user interface. For example, the user interface may be a touch screen including a touch-sensitive surface that overlays the display 105. In another embodiment, the user interface or touch screen of the electronic device 100 may include a touch-sensitive surface supported by the housing 101 that does not overlay any type of display. In yet another embodiment, the user interface of the electronic device 100 may include one or more input keys 107. Examples of the input keys 107 include, but are not limited to including, keys of an alphabetic or numeric keypad or keyboard, physical keys, touch-sensitive surfaces, mechanical surfaces, multipoint direction keys, or side buttons or side keys 107.

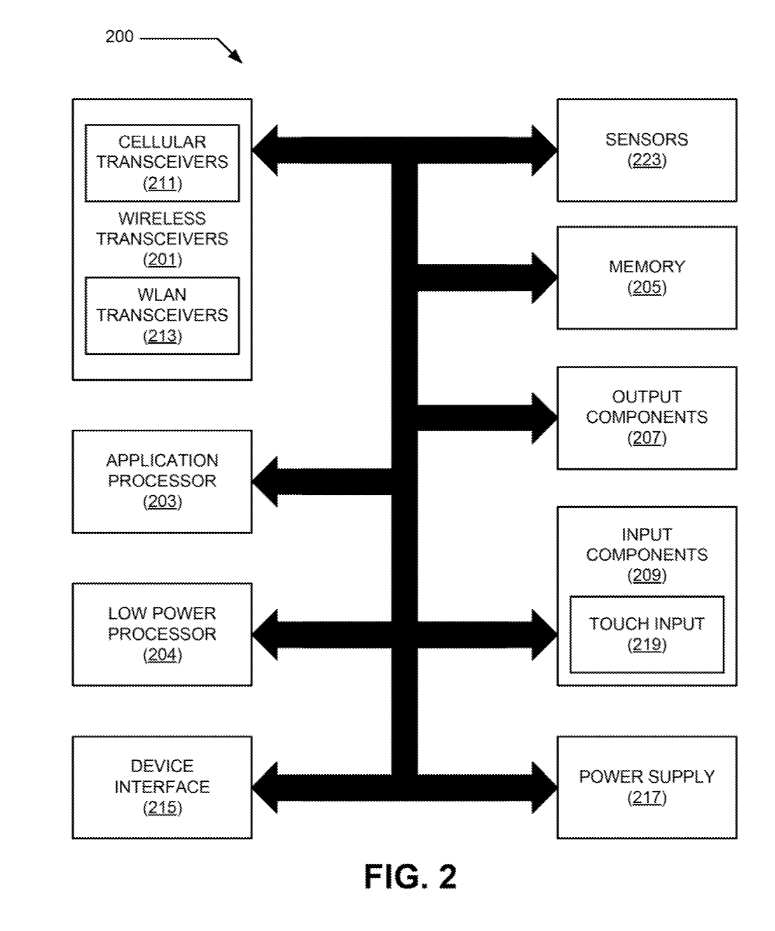

The electronic device 100 may also comprise apertures 109, 111 for audio output and input at the surface. It is to be understood that the electronic device 100 may include a variety of different combinations of displays and interfaces. The electronic device 100 may include one or more sensors 113 positioned at or within an exterior boundary of the housing 101. For example, as illustrated by FIG. 1, the sensors 113 may be positioned at the front surface 103 or another surface (such as one or more side surfaces 115) of the exterior boundary of the housing 101. Wherever the sensors 113 are supported by the housing 101, whether at the exterior boundary or within the exterior boundary (e.g., internal to the housing), the sensors detect a predetermined environmental condition associated with an environment external or internal to the housing. Examples of the sensors are described below in reference to FIG. 2.

Turning now to FIG. 2, a block diagram representing example components 200 which may be used in association with an embodiment of the electronic device 100 is shown. The example components 200 may include, but are not limited to including, one or more wireless transceivers 201, an application processor 203, a low power processor 204, one or more memory modules 205, one or more output components 207, and one or more input components 209. Each wireless transceiver 201 may utilize wireless technology for communication, such as, but not limited to, cellular-based communications such as analog communications, digital communications, next generation communications, and their variants, as represented by the cellular transceiver 211. Each wireless transceiver 201 may also utilize wireless technology for communication, such as, but not limited to, peer-to-peer or ad hoc communications or other forms of wireless communication such as infrared technology, as represented by the wireless local area network transceiver 213. Also, each transceiver 201 may be a receiver, a transmitter, or both.

The internal components 200 may further include a device interface 215 to provide a direct connection to auxiliary components or accessories for additional or enhanced functionality. In addition, the internal components 200 preferably include a power source or supply 217, such as a portable battery, for providing power to the other internal components and to allow portability of the electronic device 100.

Further, the application processor 203 and the low power processor 204 may both generate commands based on information received from one or more input components 209. The processors 203, 204 may process the received information alone or in combination with other data, such as the information stored in the memory 205. Thus, the memory 205 of the internal components 200 may be used by the processors 203, 204 to store and retrieve data. Additionally, the components 200 may include any additional processors aside from the application processor 203 and the low power processor 204.

The data that may be stored by the memory 205 include, but are not limited to including, operating systems, applications, and data. Each operating system includes executable code that controls basic functions of the electronic device 200, such as interaction among the components of the internal components 200, communication with external devices via each transceiver 201 or the device interface 215, and storage and retrieval of applications and data to and from the memory 205. Each application may include executable code utilizing an operating system to provide more specific functionality for the electronic device 100. Data are non-executable code or information that may be referenced or manipulated by an operating system or application for performing functions of the electronic device 100.

The input components 209, such as a user interface, may produce an input signal in response to detecting a predetermined gesture at a touch input 219, which may be a gesture sensor. In the present example, the touch input 219 is an example touch-sensitive surface substantially parallel to the display. The touch input 219 may further include at least one capacitive touch sensor, a resistive touch sensor, an acoustic sensor, an ultrasonic sensor, a proximity sensor, or an optical sensor.

The input components 209 may also include other sensors, such as a visible light sensor, a motion sensor, and a proximity sensor. Likewise, the output components 207 of the internal components 200 may include one or more video, audio, or mechanical outputs. For example, the output components 207 may include a video-output component such as a cathode-ray tube, liquid-crystal display, plasma display, incandescent light, fluorescent light, front or rear projection display, or a light-emitting diode indicator. Other examples of output components 207 include an audio-output component such as a speaker, alarm, or buzzer, or a mechanical output component such as vibrating or motion-based mechanisms.

Although the input components 209 described above are intended to cover all types of input components included or utilized by the electronic device 100, the components 200 may include additional sensors 223 that may be included or utilized by the device 100. The various sensors 223 may include, but are not limited to, power sensors, temperature sensors, pressure sensors, moisture sensors, motion sensors, accelerometer or gyroscopic sensors, or other sensors, such as ambient-noise sensors, light sensors, motion sensors, proximity sensors, and the like.

It is to be understood that FIG. 2 is provided for illustrative purposes only and for illustrating components of an electronic device 100 usable in accordance with one or more embodiments of the disclosed principles and is not intended to be a complete schematic diagram of the various components required for an electronic device 100. Therefore, an electronic device 100 may include various other components not shown in FIG. 2, or may include a combination of two or more components or a division of a particular component into two or more separate components, and still be within the scope of the disclosure.

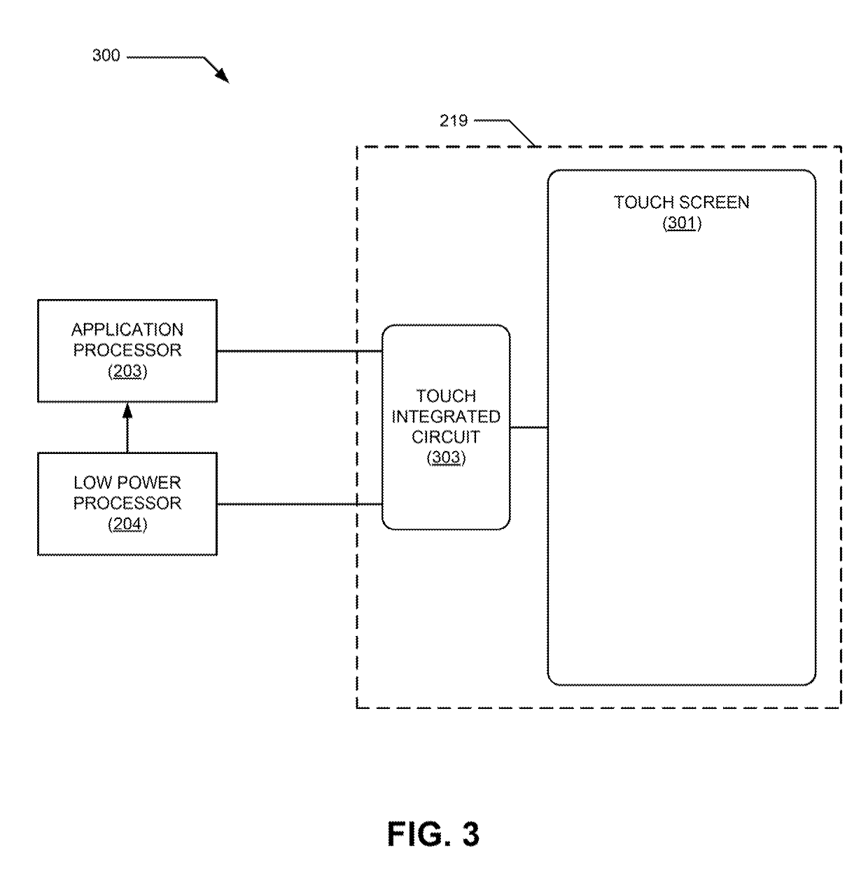

Referring now to FIG. 3, an example component configuration 300 is shown. In the example embodiment of FIG. 3, the low power processor 204 is operatively coupled to the touch-input system 219. Additionally, the low power processor 204 is operatively coupled to the application processor 203. The touch-input system 219 may include a touch-input screen 301 and a touch integrated circuit 303. In some examples, the touch integrated circuit 303 receives a user input (a “touch”) from the touch-input screen 301. The touch integrated circuit 303 may generate and send touch data to the low power processor 204 based on the touch. Additionally, the touch integrated circuit 303 may send the touch data to the application processor 203. In some alternative embodiments, the touch input system 219 may not include a touch integrated circuit 303 and may send touch signals directly to the processors 203, 204.

In some embodiments, the application processor 203 may be in a very low power state (a “sleep mode”). While the application processor 203 is in a sleep mode, the low power processor 204 receives information associated with a touch from the touch-input system 219. The touch information may include a location of the touch on the touch-input screen 301 and may be a single-point touch, a multi-point touch, or any recognizable gesture. When the low power processor 204 receives the touch information, based on the location of the touch, the low power processor 204 will either ignore the touch or wake the application processor 203.

Waking the application processor 203 may be done by sending a handover signal from the low power processor 204 to the application processor 203. In some examples, the application processor 203 may receive information associated with the touch from the touch input 219 upon waking from the sleep mode. Further, the application processor 203 may transition from the sleep mode to a non-sleep mode upon waking

In some examples, the low power processor 204 is configured for displaying information via the touch screen 301 while the application processor 203 is in sleep mode. Additionally or alternatively, the application processor 203 may display information via the touch screen 301 while the application processor 203 is in the non-sleep mode.

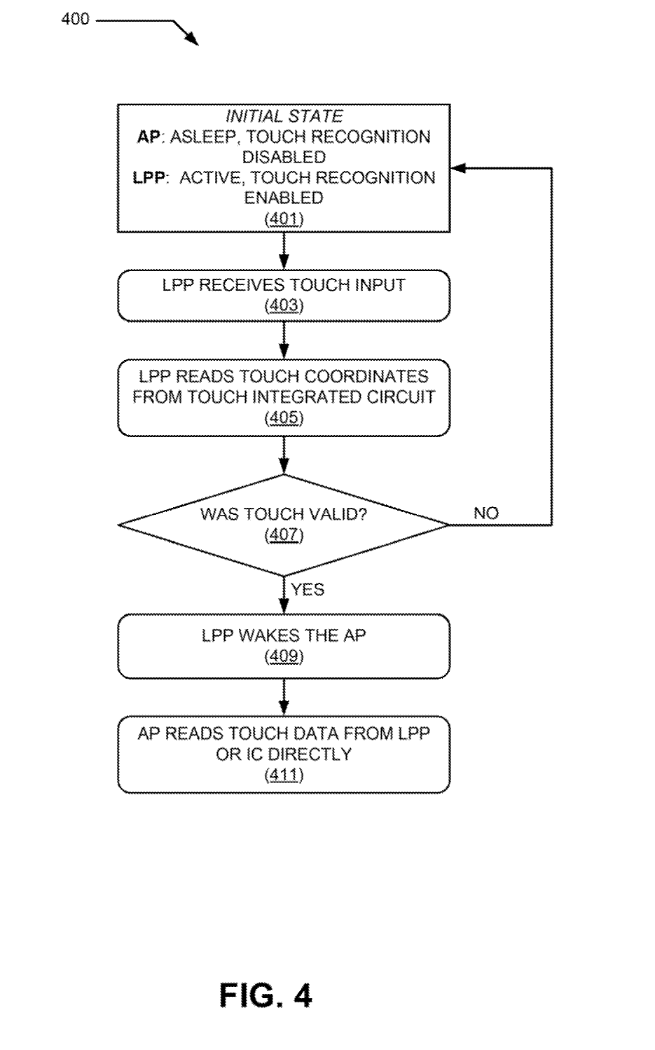

Continuing, the flow chart 400 of FIG. 4 shows an example of an operational flow of a process for responding to a touch input by the electronic device 100. At stage 401, the electronic device 100 is in an initial state wherein the application processor 203 is in a sleep mode (“asleep”) and does not receive touch input from the touch input system 219, while the low power processor 204 is active and able to receive touch input from the touch input system 219. In the illustrated example, the low power processor 204 receives a touch input at stage 403 and reads the touch coordinates from the touch input system 219 or from its associated touch integrated circuit 303 at stage 405. The low power processor 204 determines whether the touch input is valid or not (stage 407). If the touch is valid, then the low power processor 204 wakes the application processor 203 at stage 409. Upon waking, the application processor 203 reads touch data from the low power processor 204 or from the touch input system 219 directly (stage 411).

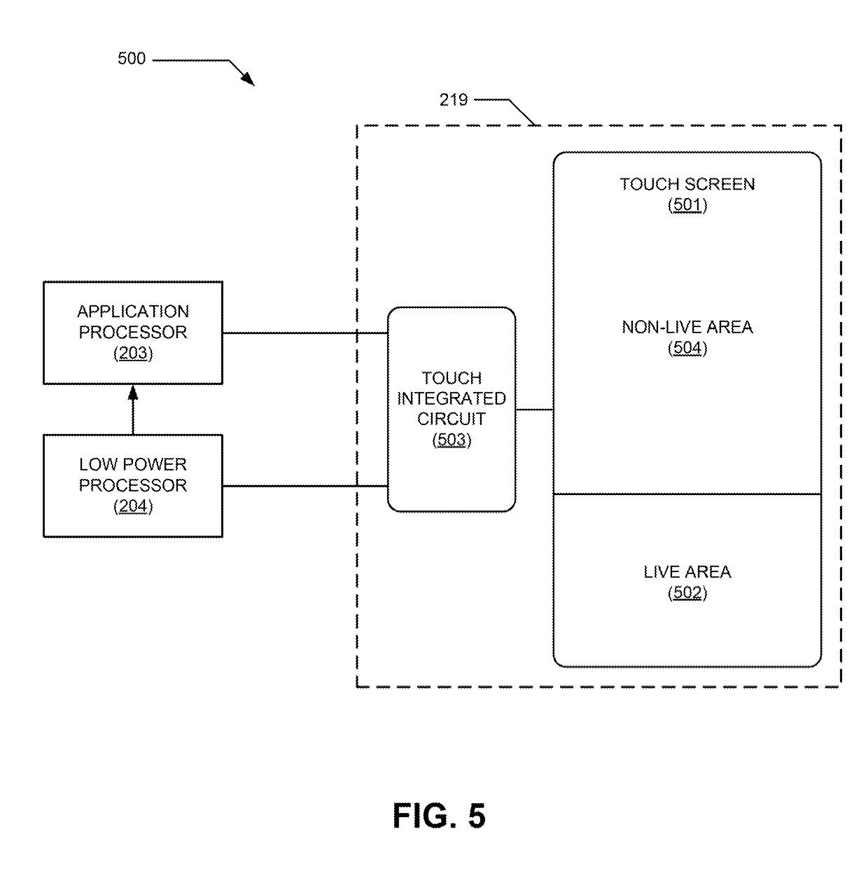

In an alternative embodiment shown in FIG. 5, the touch-input system 219 may include a touch screen 501, wherein the low power processor 204 logically divides the touch screen 501 into “live” areas 502 and “non-live” areas 504. For example, in an embodiment, prior to entering a sleep mode, the application processor 203 may display a few clickable icons on the touch screen 501 (or it may instruct the low power processor 204 to display these icons). Areas associated with these icons are the live areas 502 and considered to be “live,” while the remainder of the screen is the non-live areas 504 and considered to be “non-live.”

If, while the application processor 203 is asleep, a touch is received that corresponds to the live areas 502, then the second processor 204 wakes the first processor 203. Touches received in non-live areas 504 are ignored. Because the designations of the areas of the screen as live or non-live ultimately depends upon the first processor 203, these areas 502, 504 may change over time.

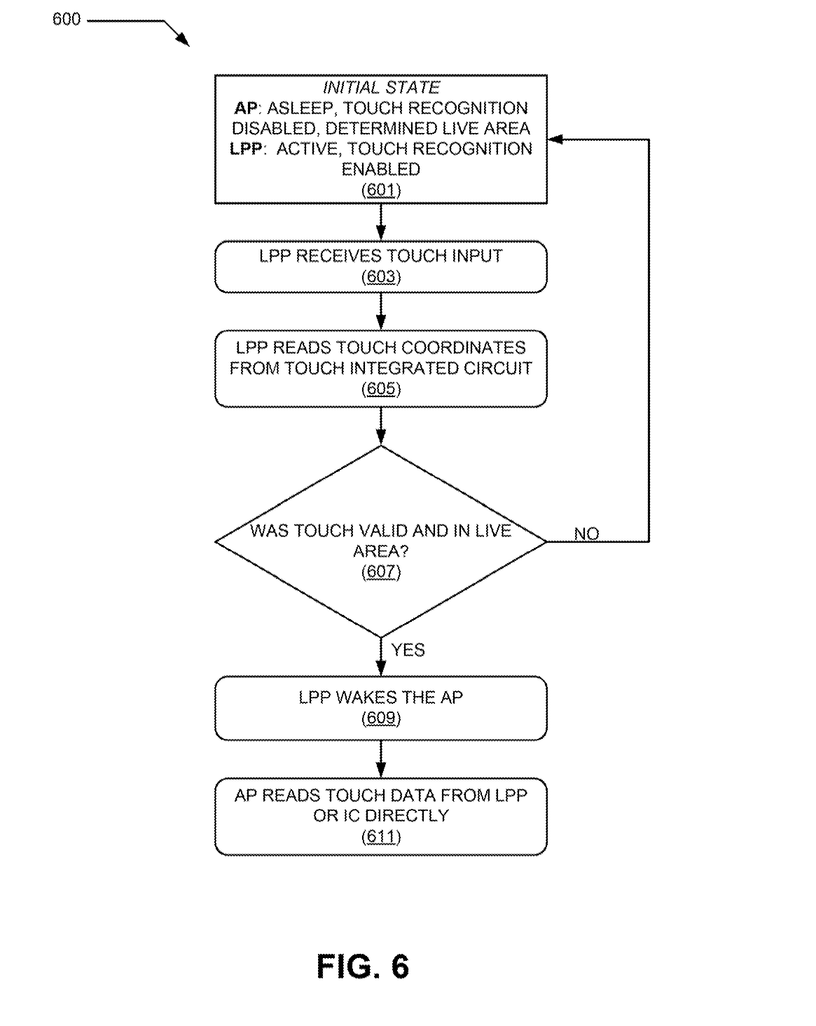

The flow chart 600 of FIG. 6 shows an example of an operational flow for the disclosed method for responding to a touch input by an electronic device 100. At stage 601, the initial state of the electronic device 100 is such that the application processor 203 is in a sleep mode (“asleep”) and does not respond to touch input from the touch input system 219. At this time, the application processor 203 has determined live areas 502, and the low power processor 204 is active and receives touch input from the touch input system 219. At stage 603, the low power processor 204 receives a touch input and reads the touch coordinates from the touch input system 219 or from its associated touch integrated circuit 503 (stage 605). The low power processor 204 then determines at stage 607 whether or not the touch input is valid. If the touch input is valid and within a live area 502, then the low power processor 204 wakes the application processor 203 at stage 609. Upon waking, the application processor 203 reads the touch data from the low power processor 203 or from the touch input system 219 directly at stage 611.

In view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method for responding to a touch input on an electronic device, the electronic device having a touch-input system, a first processor supporting a sleep mode and an awake mode, and a second processor, the first processor distinct from the second processor, the method comprising:
while the first processor is in the sleep mode:
receiving, by the second processor from the touch-input system, information associated with a touch, the information comprising a location of the touch on a screen of the touch-input system; and
based, at least in part, on the location of the touch, selecting an action from the group consisting of: ignoring the touch at the second processor and waking the first processor by the second processor such that the first processor transitions from the sleep mode to the awake mode.

2. The method of claim 1 wherein the touch is selected from the group consisting of:
a single-point touch, a multi-point touch, and a gesture.

3. The method of claim 1 wherein the second processor displays information via the touch-input system while the first processor is in the sleep mode.

4. The method of claim 1 wherein the second processor logically divides the touch-input screen into live and non-live areas, the second processor ignoring a touch in a non-live area, and the second processor waking the first processor for a touch that is at least in part in a live area.

5. The method of claim 1 wherein waking the first processor comprises sending a handover signal to the first processor.

6. The method of claim 1 wherein waking the first processor by the second processor further includes sending information about the touch from the second processor to the first processor.

7. The method of claim 1 further comprising receiving information associated with the touch at the first processor from the touch-input system.

8. The method of claim 1 wherein the first processor transitions itself from the sleep mode to the awake mode upon being awakened.

9. The method of claim 1 wherein the first processor displays information via the touch-input system while the first processor is in the awake mode.

10. An electronic device configured for responding to a touch input, the electronic device comprising:
a touch-input system;
a first processor; and
a second processor operatively coupled to the touch-input system and to the first processor, the second processor distinct from the first processor, the second processor configured for:
while the first processor is in a sleep mode:
receiving, from the touch-input system, information associated with a touch, the information comprising a location of the touch on a screen of the touch-input system; and
based, at least in part, on the location of the touch, executing an action selected from the group consisting of: ignoring the touch and waking the first processor.

11. The electronic device of claim 10 wherein the electronic device is selected from the group consisting of: a personal electronic device, a mobile telephone, a personal digital assistant, and a tablet computer.

12. The electronic device of claim 10 wherein the first processor is an application processor and the second processor is a sensor hub.

13. The electronic device of claim 10 wherein the touch is selected from the group consisting of: a single-point touch, a multi-point touch, and a gesture.

14. The electronic device of claim 10 wherein the second processor is configured to display information via the touch-input system while the first processor is in the sleep mode.

15. The electronic device of claim 10 wherein the second processor is configured to logically divide the touch-input screen into live and non-live areas, to ignore a touch located in a non-live area, and to wake the first processor for a touch located at least in part in a live area.

16. The electronic device of claim 10 wherein waking the first processor includes sending a handover signal to the first processor.

17. The electronic device of claim 10 wherein the second processor is further configured to send information about the touch to the first processor upon waking the first processor.

18. The electronic device of claim 10 wherein the first processor is configured to receive information associated with the touch from the touch-input system upon waking

19. The electronic device of claim 10 wherein the first processor is configured to transition itself from the sleep mode to the awake mode.

20. The electronic device of claim 10 wherein the first processor is configured to display information via the touch-input system while the first processor is in the awake mode.
